(19) United States
(12) Patent Application Publication
(10) Pub. No.: US 2013/0203882 A1
(43) Pub. Date: Aug. 8, 2013

(54) Curable Composition

(71) Applicants: Zoubair Cherkaoui, Allschwill (CH); Richard Frantz, Bartenhelm (FR); Emille Galand, Blotzheim (FR); Matthias Graeber, Uzwil (CH); Dimiter Kotzev, Brunnen (CH)

(72) Inventors: Zoubair Cherkaoui, Allschwill (CH); Richard Frantz, Bartenhelm (FR); Emille Galand, Blotzheim (FR); Matthias Graeber, Uzwil (CH); Dimiter Kotzev, Brunnen (CH)

(73) Assignee: Huntsman International LLC, The Woodlands, TX (US)

(21) Appl. No.: 13/643,560

(22) PCT Filed: Feb. 9, 2011
(86) PCT No.: PCT/EP2011/051907

§ 371 Date: Nov. 5, 2012

(30) Foreign Application Priority Data
Apr. 29, 2010 (EP) 10161452.7

(51) Int. Cl. C09D 183/04

(52) U.S. Cl. CPC C09D 183/04
USPC 522/31

(57) ABSTRACT

Photocurable composition curable by ultraviolet (UV) radiation comprising: A) at least one organosiloxane component A of the following formula (I): whereby Pa and Pb are each independently selected from a cationically polymerizable group, x+y is an integer ≧1, Sp and Sp′ are each independently selected from a cycloaliphatic hydrocarbon group and an aliphatic linear or branched hydrocarbon group, R₁ and R₂ are each independently linear or branched aliphatic or cycloaliphatic, alkoxy, aromatic or hetero aromatic groups; B) at least one second organosiloxane component B of the following formula (II): whereby n is an integer ranging from 7 to 300, x+y is an integer ≧1, Pa and Pb are each independently selected from a cationically polymerizable group, Sp and Sp′ are each independently selected from a cycloaliphatic hydrocarbon group and aliphatic linear or branched hydrocarbon group, R₁, R₂, R₃, R₄ are each independently linear or branched aliphatic or cycloaliphatic, alkoxy, aromatic or hetero aromatic group; C) at least one epoxy and/or oxetane component C without siloxane groups; D) at least one cationic photoinitiator D.

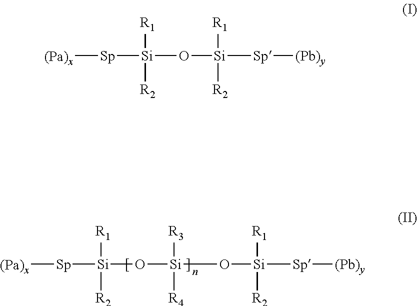

### BACKGROUND OF THE INVENTION

1. Field of the Invention

The present invention relates to curable compositions capable of providing cured coatings/films with outstanding light scattering/diffusing properties along with high light transmission properties, suited to be used, in particular, for the production of light-emitting devices.

2. Related Art

Organic light emitting devices (“OLEDs”), including both polymer and small-molecule OLEDs, are the next generation technology which is already commercialised in display technology, e.g., cell phones, MP3 players, lap-top computers, televisions, and car audio systems. So far the emphasis of OLED research has been on display applications, but an application field of solid state lighting and signals is emerging. OLEDs provide major advantages such as low power consumption, easy processing of large-area devices, and freedom in shape and colour design in comparison to traditional solid light sources.

The light generation in OLEDs is due to the radiative recombination of excitons on electrically excited organic molecules. Light is generated from thin organic emitting layer spontaneously in all the directions and propagates via various modes, that is, external modes (escape from the substrate surface), substrate, and ITO/organic waveguided modes due to total internal reflection. According to classical ray optics theory about 80% of generated light is lost in wave-guided modes due to for instance glass substrate and ITO/organic material which means that the majority of the light is either trapped inside the glass substrate and device, or emitted out from the edges of an OLED device. These phenomena result in decreased light extraction, and consequently in reduction of the brightness of the OLED.

Numerous techniques have been implemented for enhancing the light extraction, also called light outcoupling, of OLEDs. For the application in general lighting the light extraction through light scattering is one of the effective choices because it offers inherent advantages, like constant color over all observation angles, symmetric illumination and uniform and Lambertian distribution. As an example, US 2003127973 describes an OLED having increased light outcoupling efficiencies. Such OLED comprises a substrate, an active region positioned on the substrate, wherein the active region comprises an anode layer, a cathode layer and a light-emitting layer disposed between the anode layer and the cathode layer; and a polymeric layer disposed over the active region, under the active region, or both under or over the active region. The polymeric layer has microparticles incorporated therein, and the microparticles are effective to increase the light-outcoupling efficiency of the OLED. The microparticles are preferably comprised of a transparent material, preferably an inorganic material such as a metal, metal oxide, e.g., TiO₂, or other ceramic material having a relatively high index of refraction. Preferably, the microparticles will have an index of refraction of greater than about 1.7. The microparticles are preferably substantially smaller than the largest dimension of any active region or pixel in a display comprising an OLED device of the invention. The microparticles preferably will have a size greater than the wavelength λ of light generated by the OLED. Thus, the microparticles will preferably have a particle size greater than about 0.4 μm-0.7 μm. The microparticles will preferably have a size in the range of from about 0.4 μm to about 10 μm or greater.

U.S. Pat. No. 7,109,651 discloses an organic electroluminescence cell including at least one organic layer and a pair of electrodes. The organic layer includes a light-emitting layer that is sandwiched between the pair of electrodes. The pair of electrodes includes a reflective electrode and a transparent electrode. The organic electroluminescence cell is formed to satisfy the expression; B₀<B_{θ} in which B₀ is a frontal luminance value of luminescence radiated from a light extraction surface to an observer, and B_{θ} is a luminance value of the luminescence at an angle of from 50 DEG to 70 DEG. A reflection/refraction angle disturbance region is provided so that the angle of reflection/refraction of the luminescence is disturbed while the luminescence is output from the light-emitting layer to the observer side through the transparent electrode. The organic electroluminescence cell is provided with a region for disturbing the angle of reflection/refraction of light between the light-emitting layer and an output medium on the observer side. In an embodiment the region comprises a dispersion of microdomains. From the point of view of the dispersion/distribution of micro domains, a combination such as brings phase separation is preferred. The dispersion/distribution can be controlled on the basis of mutual solubility of materials combined. The phase separation can be performed by a suitable method such as a method of dissolving mutually insoluble materials in a solvent or a method of mixing mutually insoluble materials while thermally melting the mutually insoluble materials.

For the production of light-emitting devices and/or OLEDs coatings and/or layers are therefore required, which are highly opaque and at the same time highly light transmitting. Opaque means that the light beams are not transmitted directly without reflections, refractions and/or diffusion through the layer. An optical image at one side of the layer cannot therefore be reproduced at the other side of the layer by light beams travelling through the layer. Such a layer is therefore non transparent. Light transmitting means that the light beams are transmitted through the layer, can penetrates into one side of the layer, and exit from the other side of the layer, whereby reflections, refractions and/or diffusion may occur inside the layer itself. Light is for example deviated from its trajectory as it reaches non-uniformities (micrometer sized phase separated domains with different refractive indexes) of the coating through which it passes. When illuminating the film with a point light source, the light is redirected/diffused and produces uniform illumination over a wide area. Such a coating is usually used to extract more light (improved luminescence) from light emitting devices which suffer from light losses.

Conventional methods to produce layers with such optical properties exhibit dramatic disadvantages.

Surface patterning and shaping, and the use of microlenses require quite complicated and expensive set-ups. Furthermore, it is difficult to reproduce such a technology at higher scale in a cost effective way. Microlenses are very expensive and extremely difficult to reproduce over large areas. They cannot be integrated into a coatable solution. They can be integrated into a device only through cautious and delicate lamination processes.

Liquid crystals are expensive. The phase separation must be obtained prior to curing. The liquid crystalline phase is limited by a certain temperature (clearing temperature), over which the liquid crystalline phase is lost and the mixture becomes transparent due to closer liquid crystal material and matrix refractive indexes.

Producing scattering films by adding scattering fillers is probably the easiest solution, but the fillers will often settle out over time and their incorporation into polymerizable compositions generally requires the composition to be repeatedly homogenized, e.g. by stirring. In addition, fillers usually reduce light transmission through the matrix and limit the overall brightness efficiency of the device. Using fillers in the liquid formulation is also limited by the phenomenon of aggregation, which reduces the formulation pot life and the coating quality as function of time. They also induce surface roughness and difficulties in controlling it.

The fillers in the liquid phase also increase the viscosity and make difficult or impossible the use of modern deposition processes, such as inkjet printing for example.

It is an object of the present invention to at least partially overcome the disadvantages of the prior art. It is an object of the invention, in particular, to provide a curable composition, which, upon curing, produces layers with good mechanical properties which are highly light transmitting and at the same time highly opaque, i.e. highly non transparent. It is also an object of the invention to provide a method to produce layers with good mechanical properties, which are highly light transmitting and at the same time highly opaque, i.e. highly non transparent. It is also an object of the invention to maximize the ratio diffuse transmission/total transmission of the light transmitted through the film.

The object of the present invention is solved according to the features of the following independent claims.

### SUMMARY OF THE INVENTION

According to a first aspect of the invention a composition curable by ultraviolet (UV) radiation and/or heat is provided comprising:

### A) An Organosiloxane Component A of the Following Formula (I):

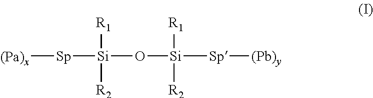

whereby
Pa and Pb are independently selected from a cationically polymerizable group,
x+y is an integer ≧1,
Sp and Sp′ are independently selected from a cycloaliphatic or aliphatic linear or branched hydrocarbon group,
R₁ and R₂ are independently linear or branched aliphatic or cycloaliphatic, alkoxy, aromatic or hetero aromatic group;

### B) A Second Organosiloxane Component B of the Following Formula (II):

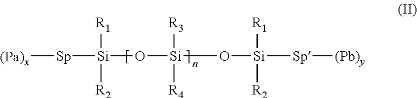

whereby
n is an integer ranging from 7 to 300,
x+y is an integer ≧1,
Pa and Pb are independently selected from a cationically polymerizable group,
Sp and Sp′ are independently selected from a cycloaliphatic or aliphatic linear or branched hydrocarbon group,
R₁, R₂, R₃, R₄ are independently linear or branched aliphatic or cycloaliphatic, alkoxy, aromatic or hetero aromatic group;
   C) an epoxy and/or oxetane component C without siloxane groups;
   D) a cationic initiator D.

Such cationically polymerizable (by photocuring or thermal curing) formulations give surprisingly rise, upon curing, to layers/coatings with outstanding light scattering/diffusing properties and high transmission. The produced layers are highly light transmitting and highly opaque. The cured films comprise regularly distributed micrometer-sized domains of a dispersed first organic component embedded by a second component, the first and the second component having a mutually different refractive index.

According to a preferred embodiment of the invention the curable composition comprises:

A) 15-75%, preferably 25-65%, more preferably 35-55% by weight of component A;
B) 15-75%, preferably 25-65%, more preferably 35-55% by weight of component B;
C) 1-40%, preferably 3-25%, more preferably 5-15% by weight of component C;
D) 0.1-10%, preferably 1-7%, more preferably 1.5-5% by weight of component D;
each based on the total weight of the composition.

According to a preferred embodiment of the invention the curable composition comprises:

A) 25-65% by weight of component A;
B) 25-65% by weight of component B;
C) 3-25% by weight of component C;
D) 1-7% by weight of component D;
each based on the total weight of the composition.

According to a preferred embodiment of the invention the curable composition comprises:

A) 35-55% by weight of component A;
B) 35-55% by weight of component B;
C) 5-15% by weight of component C;

D) 1.5-5% by weight of component D;

each based on the total weight of the composition.

According to another preferred embodiment of the invention at a temperature of 25° C. and a pressure of 1 bar in the curable composition:

the amount of component C is not soluble in the amount of component B;
the amount of component C is soluble in the amount of component A;
the amount of component B is soluble in the amount of component A.

The amount of a component is soluble into the amount of another component, when, upon mixing together, said two components give rise to one phase only at a defined temperature (25° C.) and pressure (1 bar).

The formulation comprises preferably at least two mutually immiscible substances, which may be a reactive polar organic substance and a reactive non-polar organosiloxane component. The formulation also comprises preferably a reactive organosiloxane diluent soluble with each one of the two immiscible substances, in order to crosslink the phase separating phases and “freeze” the structure into a film. This allows both matrices to crosslink together for making a film. In addition, other organic or inorganic substances may be present in the composition used for producing the organic layer. Light is reflected/scattered/diffused at the interfaces between separated phase domains, and this phenomenon is responsible for the outstanding diffusion properties of the films.

An organic layer having dispersed domains of a first component that are embedded by a second component may be obtained by preparing a dispersion of at least a first liquid organic substance into at least a second liquid organic substance, which liquid organic substances are mutually immiscible. Immiscible organic substances are considered to be organic substances that substantially do not dissolve into each other. In this embodiment the first organic substance is dispersed in the second organic substance, for example by stirring. This has the advantage that the average size of the domains formed by the first component and therewith the optical properties of the organic layer can be controlled when forming the dispersion. The two mutually immiscible substances in the organic layer may include a polar organic substance and a non-polar substance. In addition, two or more organic substances may be present in the composition used for providing the organic layer.

In another embodiment of the invention the step of curing the organic layer causes a phase separation resulting in formation of the domains of the first component embedded by the second component. In that case the organic substances used for preparing the organic layer may be mutually miscible. This has the advantage that they can be prepared as a stable mixture that is immediately available for use in the manufacturing process. The mixture may even be stored in a printing unit used for applying the organic layer, therewith avoiding the necessity to clean the printing unit when not in use.

The organic layer comprising domains of a dispersed first organic component embedded by a second component, the first and the second component having a mutually different refractive index, causes radiation to be refracted at the interfaces of these components. Attached to a white OLED for instance, such a light scattering layer/foil would change photon trajectory randomly and allow recycling of all substrate light modes. Hence photons reflected at the interface to air may be redirected to the OLED surface, increasing the total light extraction probability and OLED efficiency.

It is furthermore an advantageous that the dispersion can be applied in liquid form. For example, the substances can be in a solved or in a molten state. Liquid organic substances may be used that are subsequently cured by polymerizing. If desired, one of the organic substances may remain in liquid form as islands in the solid sea formed by the other substance. As the dispersion can be applied in a liquid form it can be easily planarized, contrary to mixtures comprising solid particles. Additionally, using the dispersion is advantageous for manufacturing processes, e.g. printing as it tends less to stick to the manufacturing machinery.

According to a preferred embodiment of the invention n in component B of the curable composition is an integer ranging from 7 to 300, preferably from 7 to 100, more preferably from 7 to 50.

According to a preferred embodiment of the invention x and/or y are 1 in component A and/or component B of the curable composition.

According to a preferred embodiment of the invention Pa and/or Pb are epoxy groups in component A and/or component B of the curable composition.

According to a preferred embodiment of the invention Pa and/or Pb are cycloaliphatic epoxy groups in component A and/or component B of the curable composition.

According to a preferred embodiment of the invention R1 and/or R2 in component A and/or component B of the curable composition are linear aliphatic groups with 1 to 3 C atoms.

According to a preferred embodiment of the invention component A of the curable composition is bis[2-(3,4-epoxycyclohexyl)ethyl]tetramethyldisiloxane.

According to a preferred embodiment of the invention Pa and/or Pb in component B of the curable composition are epoxycyclohexyl groups and R1 and/or R2 in component B of the curable composition are methyl groups.

According to a preferred embodiment of the invention component C of the curable composition is selected from the group of a cycloaliphatic epoxy resins with 2 epoxy groups, diglycidyl ether of hydrogenated Bisphenol A and trimethylolpropane oxetane.

According to a second aspect of the invention a method of producing an opaque light-transmitting layer is provided comprising the step of:

a) providing a layer with a thickness from 5 to 300 micrometers of a curable composition;
b) curing said layer with UV radiation and/or heat.

The coating/film is cured very quickly using UV light and/or heat and can be applied by any printing or spraying technique. It can be coated at any stage of a process, on any device shape, and integrated easily into an in-line process.

The produced organic layer typically has a thickness between 5 and 300 μm. An organic layer substantially thicker than 300 μm, e.g. thicker than 500 μm may result in an excessive absorption of radiation and low light transmission.

Such an organic layer exhibits therefore preferably a thickness between 5 and 100 μm.

The step of curing the organic layer causes preferably a phase separation resulting in the formation of domains of a first phase (island phase) embedded by a second phase (sea phase). The separating phases of the films exhibit preferably different refractive indexes.

The size of the phase separated domains is preferably larger than the wavelength of the emitted light for allowing interaction of the light with the different phases and the final brightness enhancement properties. This means that the island phase domains exhibit preferably a diameter in the range of 0.5 to 20 μm, preferentially from 1 to 10 μm.

The domains of the first phase form preferably lens-like elements.

Such lens-like elements exhibit preferably a diameter in the range of 0.5 to 20 μm, preferentially 1 to 10 μm.

According to a third aspect of the invention an opaque light-transmitting layer is provided exhibiting a light transmission higher than 70%, preferably higher than 80%, in the light wavelength range from 400 to 700 nm, whereby the ratio diffused transmitted light/total transmitted light is higher than 90% in the light wavelength range from 400 to 700 nm.

Acrylates may be added into the compositions to the cationic polymerizable components, so as to create a hybrid epoxy/acrylate network.

(A) Organosiloxane Component A with Formula (I)

According to the present invention, the curable resin composition comprises at least one organosiloxane component A of the following formula (I):

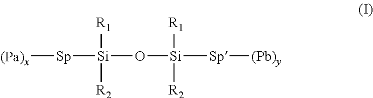

whereby
Pa and Pb are independently selected from a cationically polymerizable group,
x+y is an integer ≧1,
Sp and Sp′ are independently selected from a cycloaliphatic or aliphatic linear or branched hydrocarbon group,
R₁ and R₂ are independently linear or branched aliphatic or cycloaliphatic, alkoxy, aromatic or hetero aromatic group.

Examples of such compounds A are: Bis[2-(3,4-epoxycyclohexyl)ethyl]tetramethyldisiloxane, 1,3-bis(glycidoxypropyl)tetramethyldisiloxane.

The following are examples of commercially available cationically curable monomers for component A: PC1000 (Polyset), SIB1115.0 (Gelest). Most preferred is PC1000.

(B) Second Organosiloxane Component B with Formula (II)

According to the present invention, the curable resin composition comprises at least one second organosiloxane component B of the following formula (II):

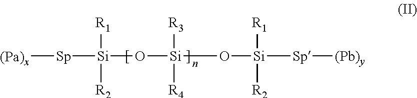

whereby
n is an integer ranging from 7 to 300,
x+y is an integer ≧1,
Pa and Pb are independently selected from a cationically polymerizable group,
Sp and Sp′ are independently selected from a cycloaliphatic or aliphatic linear or branched hydrocarbon group,
R₁, R₂, R₃, R₄ are independently linear or branched aliphatic or cycloaliphatic, alkoxy, aromatic or hetero aromatic group;

Examples of such compounds B are: Epoxypropoxypropyl terminated polydimethylsiloxanes, epoxypropoxypropyl terminated polyphenylmethylsiloxanes, (epoxypropoxypropyl)dimethoxysilyl terminated polydimethylsiloxanes, mono-(2,3-epoxy)propylether terminated polydimethylsiloxane, epoxycyclohexylethyl terminated polydimethylsiloxanes.

The following are examples of commercially available cationically curable monomers for component B: DMS-E12, DMS-E21, DMS-EX21, MCR-E11, MCR-E21, DMS-EC13 (Gelest); UV9200 (Momentive), Silcolease UV POLY220, Silcolease UV POLY200, Silcolease UV POLY201 (Bluestar).

(C) Epoxy and/or Oxetane Component C without Siloxane Groups

According to the present invention, the curable resin composition comprises at least a cationically curable organic component C without siloxane groups.

Such cationically curable organo component C includes at least one cationically curable compound characterized by having functional groups capable of reacting via or as a result of a ring-opening mechanism initiated by cations to form a polymeric network. Examples of such functional groups include oxirane-(epoxide), and oxetane rings in the compound. Such compounds may have an aliphatic, aromatic, cycloaliphatic, araliphatic or heterocyclic structure and they may contain the ring groups as side groups, or the functional group can form part of an alicyclic or heterocyclic ring system. Such cationically curable compound C may be monofunctional, difunctional, trifunctional or may contain more than three cationically curable groups.

The cationically curable component C may include a single liquid cationically curable compound, a combination of liquid cationically curable compounds, a combination of one or more liquid cationically curable compounds and one or more solid cationically curable compounds which are soluble in the liquid, or one or more solid cationically curable compounds soluble in liquid component A.

The cationically curable component C may include one or more epoxide compounds in which the epoxide groups form part of an alicyclic or heterocyclic ring system. The alicyclic epoxide preferably includes at least one alicyclic polyepoxide having preferably at least two epoxy groups per molecule. Preferably, the alicyclic polyepoxide is in a relatively pure form in terms of oligomer (e.g. dimer, trimer, etc.) content.

Examples of alicyclic polyepoxides include bis(2,3-epoxycyclopentyl)ether, 2,3-epoxycyclopentyl glycidyl ether, 1,2-bis(2,3-epoxycyclopentyloxy)ethane, bis(4-hydroxycyclohexyl)methane diglycidyl ether, 2,2-bis(4-hydroxycyclohexyl)propane diglycidyl ether, 3,4-epoxycyclohexylmethyl 3,4-epoxycyclohexanecarboxylate, 3,4-epoxy-6-methylcyclohexylmethyl 3,4-epoxy-6-methylcyclohexanecarboxylate, di(3,4-epoxycyclohexylmethyl)hexanedioate, di(3,4-epoxy-6-methylcyclohexylmethyl)hexanedioate, ethylene b is (3,4-epoxycyclohexanecarboxylate, ethanediol di(3,4-epoxycyclohexylmethyl)ether, vinylcyclohexene dioxide, dicyclopentadiene epoxide or 2-(3,4-epoxycyclohexyl-5,5-spiro-3,4-epoxy)cyclohexane-1,3-dioxane.

The curable composition preferably includes one or more cationically curable compounds that are polyglycidyl ethers, poly(P-methylglycidyl)ethers, polyglycidyl esters, poly(P-methylglycidyl) esters, poly(N-glycidyl) compounds, and poly(S-glycidyl) compounds.

Polyglycidyl ethers can be obtained by reacting a compound having at least two free alcoholic hydroxyl groups and/or phenolic hydroxyl groups with a suitably substituted epichlorohydrin under alkaline conditions or in the presence of an acidic catalyst followed by alkali treatment. Ethers of this type may be derived, for example, from acyclic alcohols, such as ethylene glycol, diethylene glycol and higher poly(oxyethylene)glycols, propane-1,2-diol, or poly(oxypropylene)glycols, propane-1,3-diol, butane-1,4-diol, poly(oxytetramethylene)glycols, pentane-1,5-diol, hexane-1,6-diol, hexane-2,4,6-triol, glycerol, 1,1,1-trimethylolpropane, bistrimethylolpropane, pentaerythritol, sorbitol, and from polyepichlorohydrins. Suitable glycidyl ethers can also be obtained from cycloaliphatic alcohols such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or aromatic alcohols such as N,N-bis(2-hydroxyethyl)aniline or p,p′-bis(2-hydroxyethylamino)diphenylmethane, Bisphenol A, F, and S resins, and 4,4′-oxybisphenol.

Examples of preferred polyglycidyl ethers include trimethylolpropane triglycidyl ether, triglycidyl ether of polypropoxylated glycerol, and diglycidyl ether of 1,4-cyclohexanedimethanol.

The following are examples of commercially available cationically curable monomers for component C: Uvacure 1500 Uvacure 1530, Uvacure 1534 (Cytec); Epalloy 5000, the Erysis GE series (CVC Specialty Chemicals Inc.), TYG-6105, TYG-6110 (Tyger Scientific Inc.); the Araldite GY series that is Bisphenol A epoxy liquid resins, the Araldite CT and GT series that is Bisphenol A epoxy solid resins, the Araldite GY and PY series that is Bisphenol F epoxy liquids, the cycloaliphatic epoxides Araldite CY 179 and PY 284, the Araldite DY reactive diluent series (Huntsman); the Heloxy 48, Heloxy 84, Heloxy 107 (Hexion), the DER series of flexible aliphatic and Bisphenol A liquid or solid epoxy resins (Dow Corp.); Celoxide 2021, Celoxide 2021P, Celoxide 2081, Celoxide 3000, AOEX-24, Epolead GT-301, Epolead GT-401, (Daicel Chemical Industries Co., Ltd.), Glydexx N-10 (Exxon-Mobile).

Poly(N-glycidyl) compounds are obtainable, for example, by dehydrochlorination of the reaction products of epichlorohydrin with amines containing at least two amine hydrogen atoms. These amines may be, for example, n-butylamine, aniline, toluidine, m-xylylenediamine, bis(4-aminophenyl)methane or bis(4-methylaminophenyl)methane. Other examples of poly(N-glycidyl) compounds include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin. Examples of poly(S-glycidyl) compounds are di-S-glycidyl derivatives derived from dithiols, for example ethane-1,2-dithiol or bis(4-mercaptomethylphenyl)ether.

The cationically curable compound C may be an oxetane compound. The following compounds are given as examples of oxetane compounds having one oxetane ring in the compound which may be used in the present invention: 3-ethyl-3-hydroxymethyloxetane, 3-(meth)allyloxymethyl-3-ethyloxetane, (3-ethyl-3-oxetanylmethoxy)methylbenzene, 4-fluoro-[1(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenylether, isobutoxymethyl(3-ethyl-3-oxetanylmethyl)ether, isobornyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanyl methyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, bornyl(3-ethyl-3-oxetanylmethyl)ether, and the like. Other examples of oxetane compounds suitable for use include trimethylene oxide, 3,3-dimethyloxetane, 3,3-dichloromethyloxetane, 3,3-[1,4-phenylene-bis(methyleneoxymethylene)]-bis(3-ethyloxetane), 3-ethyl-3-hydroxymethyl-oxetane, and bis-[(1-ethyl(3-oxetanyl)methyl)]ether.

Examples of compounds having two or more oxetane rings in the compound which may be used in the present invention include: 3,7-bis(3-oxetanyl)-5-oxa-nonane, 3,3′-(1,3-(2-methyleny)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethyleneglycolbis(3-ethyl-3-oxetanylmethyl)ether, dicyclopentenyl bis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified Bisphenol A bis(3-ethyl-3-oxetanylmethyl)ether, PO-modified Bisphenol A bis(3-ethyl-3-oxetanylmethyl)ether, EO-modified hydrogenated Bisphenol A bis(3-ethyl-3-oxetanylmethyl)ether, PO-modified hydrogenated Bisphenol A bis(3-ethyl-3-oxetanylmethyl)ether, EO-modified Bisphenol F (3-ethyl-3-oxetanylmethyl)ether, and the like.

Commercially available oxetane compounds include trimethylolpropane oxetane (TMPO) from Perstorp, Aron Oxetane OXT-101, OXT-121, OXT-212, OXT-221, all available from Toagosei Co. Ltd.

### (D) Cationic Initiator D

According to the present invention, the curable composition comprises at least a cationic initiator D. The initiator can be an initiating system comprising a combination of different initiators and/or sensitizers. The initiating system can, however, be also a system comprising a combination of different compounds, which do not exhibit any initiating property when taken alone, but which do exhibit initiating properties when combined together. The cationic initiator may be a cationic photoinitiator or may be activated by the effect of heat and/or temperature.

The photoinitiator may be chosen from those commonly used to initiate cationic polymerization.

Examples of cationic photoinitiators include, but are not limited to, onium salts, diaryliodonium salts of sulfonic acids, triarylsulfonium salts of sulfonic acids, diaryliodonium salts of boronic acids, and triarylsulfonium salts of boronic acids, having non-nucleophilic anions such as hexafluorophosphate, hexafluoroantimonate, tetrafluoroborate and hexafluoroarsenate, tetra(pentafluorophenyl)borate.

The cationic photoinitiator can be present in the coating composition in an amount ranging from about 0.01 to 10%, preferably from 0.1 to 5% weight percent, more preferably from 0.5 to 3% based on the total weight of the coating composition.

The onium salts are positively charged, usually with a value of +1, and a negatively charged counterion is present. Suitable onium salts include salts having a formula selected from R⁹₂I⁺MX_{z}⁻, R⁹₃S⁺MX_{z}⁻, R⁹₃Se⁺MX_{z}⁻, R⁹₄P⁺MX_{z}⁻, and R⁹₄N⁺MX_{z}⁻, wherein each R⁹ is independently hydrocarbyl or substituted hydrocarbyl having from 1 to 30 carbon atoms; M is an element selected from transition metals, rare earth metals, lanthanide metals, metalloids, phosphorus, and sulfur; X is a halo (e.g., chloro, bromo, iodo), and z has a value such that the product of z times (charge on X+oxidation number of M)=−1. Examples of substituents on the hydrocarbyl group include, but are not limited to, C₁ to C₈ alkoxy, C₁ to C₁₆ alkyl, nitro, chloro, bromo, cyano, carboxyl, mercapto, and heterocyclic aromatic groups, such as pyridyl, thiophenyl, and pyranyl. Examples of metals represented by M include, but are not limited to, transition metals, such as Fe, Ti, Zr, Sc, V, Cr, and Mn; lanthanide metals, such as Pr, and Nd; other metals, such as Cs, Sb, Sn, Bi, Al, Ga, and In; metalloids, such as B, and As; and P. The formula MX_{z}⁻ represents a non-basic, non-nucleophilic anion. Examples of anions having the formula MX_{z}⁻ include, but are not limited to, BF₄⁻, PF₆⁻, AsF₆⁻, SbF₆⁻, SbCl₆⁻, and SnCl₆⁻.

Examples of onium salts include, but are not limited to, bis-diaryliodonium salts, such as bis(dodecylphenyl)iodonium hexafluoroarsenate, bis(dodecylphenyl)iodonium hexafluoroantimonate, and dialkylphenyliodonium hexafluoroantimonate.

Examples of diaryliodonium salts of sulfonic acids include, but are not limited to, diaryliodonium salts of perfluoroalkylsulfonic acids, such as diaryliodonium salts of perfluorobutanesulfonic acid, diaryliodonium salts of perfluoroethanesulfonic acid, diaryliodonium salts of perfluorooctanesulfonic acid, and diaryliodonium salts of trifluoromethanesulfonic acid; and diaryliodonium salts of aryl sulfonic acids, such as diaryliodonium salts of para-toluenesulfonic acid, diaryliodonium salts of dodecylbenzenesulfonic acid, diaryliodonium salts of benzenesulfonic acid, and diaryliodonium salts of 3-nitrobenzenesulfonic acid.

Examples of triarylsulfonium salts of sulfonic acids include, but are not limited to, triarylsulfonium salts of perfluoroalkylsulfonic acids, such as triarylsulfonium salts of perfluorobutanesulfonic acid, triarylsulfonium salts of perfluoroethanesulfonic acid, triarylsulfonium salts of perfluorooctanesulfonic acid, and triarylsulfonium salts of trifluoromethanesulfonic acid; and triarylsulfonium salts of aryl sulfonic acids, such as triarylsulfonium salts of para-toluenesulfonic acid, triarylsulfonium salts of dodecylbenzenesulfonic acid, triarylsulfonium salts of benzenesulfonic acid, and triarylsulfonium salts of 3-nitrobenzenesulfonic acid.

Examples of diaryliodonium salts of boronic acids include, but are not limited to, diaryliodonium salts of perhaloarylboronic acids. Examples of triarylsulfonium salts of boronic acids include, but are not limited to, triarylsulfonium salts of perhaloarylboronic acid. Diaryliodonium salts of boronic acids and triarylsulfonium salts of boronic acids are well known in the art, as exemplified in European Patent Application No. EP 0562922.

Examples of commercial cationic photoinitiators include UV9390C, UV9380C (manufactured by Momentive), Irgacure 250 (BASF), Rhodorsil 2074, Rhodorsil 2076 (Rhodia), Uvacure 1592 (UCB Chemicals), Esacure 1064 (Lamberti). Most preferred are UV9390C and Rhodorsil 2074.

In the case of polymerization initiated by heat, thermal activable initiators are used, such as thermal activatable onium salts, oxonium salts, iodonium salts, sulfonium salts, phosphonium salts or quaternary ammonium salts having no nucleophilic anions are used. Such initiators and their application are known. For example, in U.S. Pat. No. 4,336,363, EP-A-0 379 464 and EP-A-0 580 552 specific sulfonium salts as curing agents are disclosed for epoxy resins. In U.S. Pat. No. 4,058,401 the respective tellurium and selenium salts are describes besides the specific sulfonium salts.

For example, quaternary ammonium salts as thermal activable initiators are disclosed in EP-A-0 066 543 and EP-A-0 673 104. They are salts of aromatic heterocyclic nitrogen bases with non-nucleophilic, for example complex, halide anions such as BF₄⁻, PF₆⁻, SbF₆⁻, SbF₅(OH)⁻ and AsF₆⁻.

In general, the activation temperature of the cationic initiator is above room temperature, preferably in the range between 60 to 180° C., in particular between 90 to 150° C.

In general, the amount of the thermal activable cationic initiator comprised in the cationic curable resin is 0.05 to 30 wt %, preferably 0.5 to 15 wt %, based on the amount of the cationic polymerizable resin.

The composition can contain additional ingredients. Examples of additional ingredients include, but are not limited to, light stabilizers; sensitizers; antioxidants; fillers, such as reinforcing fillers, extending fillers, and conductive fillers; adhesion promoters; and fluorescent dyes.

### BRIEF DESCRIPTION OF THE DRAWINGS

These and other aspects are described in more detail with reference to the drawing. Therein:

FIG. 1 shows in the light wavelength range from 400 to 800 nm the measured ratio diffused transmitted light/total transmitted light for different layers produced by curing conventional curable compositions and curable compositions according to the present invention.

FIG. 1bis shows in the light wavelength range from 400 to 800 nm the measured total transmitted light for different layers produced by curing conventional curable compositions and curable compositions according to the present invention.

FIG. 2 shows a SEM picture of a film obtained by curing the formulation F1.

FIG. 2A shows more schematically the SEM picture of FIG. 2.

FIG. 3 shows an AFM picture of a film obtained by curing the formulation F1.

### DETAILED DESCRIPTION OF EMBODIMENTS

### Preparation of the Compositions

The formulations indicated in the examples were prepared by mixing the components with a magnetic stirrer (Heidolph MR Hei-End) at 500 rpm for about 10 min.

The compositions of the formulations which were studied are described in Table I. The percent in weight (wt %) based on the total weight of the composition is indicated for the siloxane components A and B, for the non-siloxane component C and for the cationic initiator D.

TABLE I

| | Renshape | | | | | | | | | | | | |
|---|---|---|---|---|---|---|---|---|---|---|---|---|---|
| | SL7840 | F1 | F2 | F3 | F4 | F5 | F6 | F7 | F8 | F9 | F10 | F11 | F12 |
| Siloxane | | | | | | | | | | | | | |
| components | | | | | | | | | | | | | |
| PC1000 | 0 | 45.25 | 49 | 41.5 | 90.5 | 45.25 | | 45.25 | 45.25 | | 45.25 | 45.25 | 45.25 |
| UV9200 | 0 | 45.25 | 49 | 41.5 | | 45.25 | 45.25 | 45.25 | 45.25 | 90.5 | 45.25 | | |
| PC1035 | | | | | | | 45.25 | | | | | 45.25 | |
| X-40-2670 | | | | | | | | | | | | | 45.25 |
| Non-siloxane | | | | | | | | | | | | | |
| components | | | | | | | | | | | | | |
| CY179 | 0 | 7.5 | 0 | 15 | 7.5 | | 7.5 | | | 7.5 | | 7.5 | 7.5 |
| Renshape SL7840 | 100 | 0 | 0 | 0 | | | | | | | | | |
| CY184 | | | | | | 7.5 | | | | | | | |
| TMPO | | | | | | | | 7.5 | | | | | |
| Epalloy 5000 | | | | | | | | | 7.5 | | | | |
| GY250 | | | | | | | | | | | 7.5 | | |
| Photoinitiator | | | | | | | | | | | | | |
| UV9390C | 0 | 2 | 2 | 2 | 2 | 2 | 2 | 2 | 2 | 2 | 2 | 2 | 2 |
| TOTAL (% weight) | 100 | 100 | 100 | 100 | 100 | 100 | 100 | 100 | 100 | 100 | 100 | 100 | 100 |
| Film formation | Yes | Yes | Yes | Yes | Yes | Yes | Yes | Yes | Yes | No | Yes | Yes | Yes |
| (3 J/cm² UVA) | | | | | | | | | | | | | |

Table II shows the trade name, the supplier, the chemical name, the CAS number and structure of each component used to produce the formulations in Table I. SL 7840 is a formulation commercially available from Huntsman comprising Epalloy 5000, a cationic photoinitiator and no siloxane component. SL 7840 is clear and becomes opaque and white by photocuring and is shown here as a comparative example. UV9200 exhibits a structure according to formula (II), whereby n is between 7 and 50.

Processing and Curing of the Films:

After mixing, the formulation was applied onto polycarbonate substrate (Makrofol DE) on a bar-coater (RK Control coater) using a plastic pipet, and then applied as a film using a wire bar. Then the film was cured in a UV oven using UVA at 3 J/cm² (Dr. Grobel UV-Mat). Finally the coating was pealed off from the polycarbonate substrate.

AFM Measurements:

AFM measurements were performed using a NT-MDT Atomic Force Microscope with SMENA scanning head, operated in semi-contact mode (1 Hz frequency and 30×30 microns scans).

Optical Measurements:

Total transmitted light and diffused transmitted light were measured on 30 micrometer thick films using a Perkin Elmer Lambda 900 spectrometer equipped with a 150 mm integrated sphere. The film was put in front of the sphere for total transmitted light measurements. Light transmission of a film is the ratio between the total light transmitted through a film and the light incident onto the film itself. For diffused transmitted light measurements the film was put far away from the hole of the integrating sphere, at 670 mm, in order to measure only the specular transmitted light going through the hole of the sphere. Specular is referred as direct transmission component (light transmitted without scatter). Then diffused transmitted light was calculated as the difference between total transmitted light and specular transmitted light.

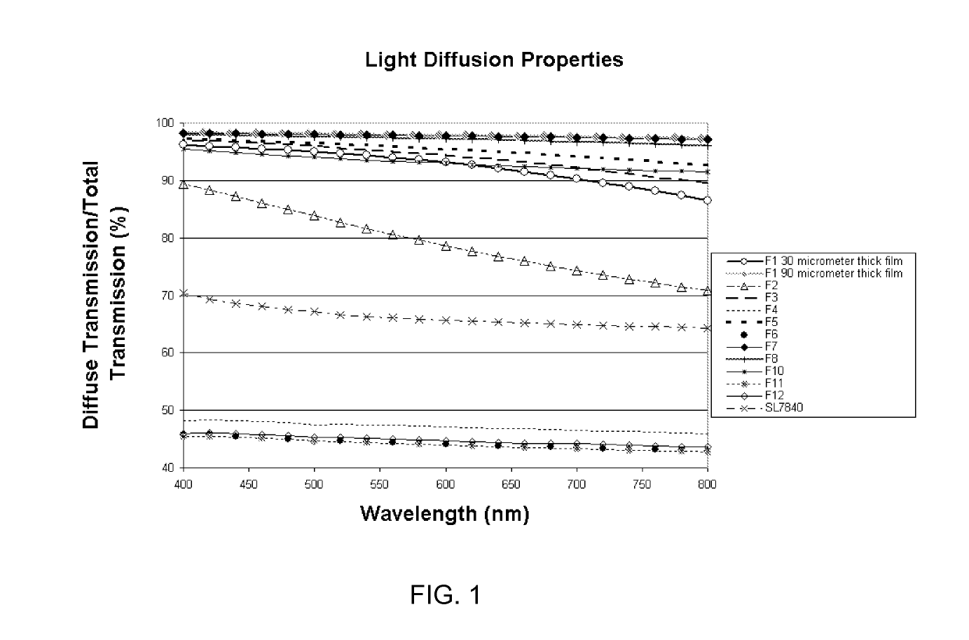

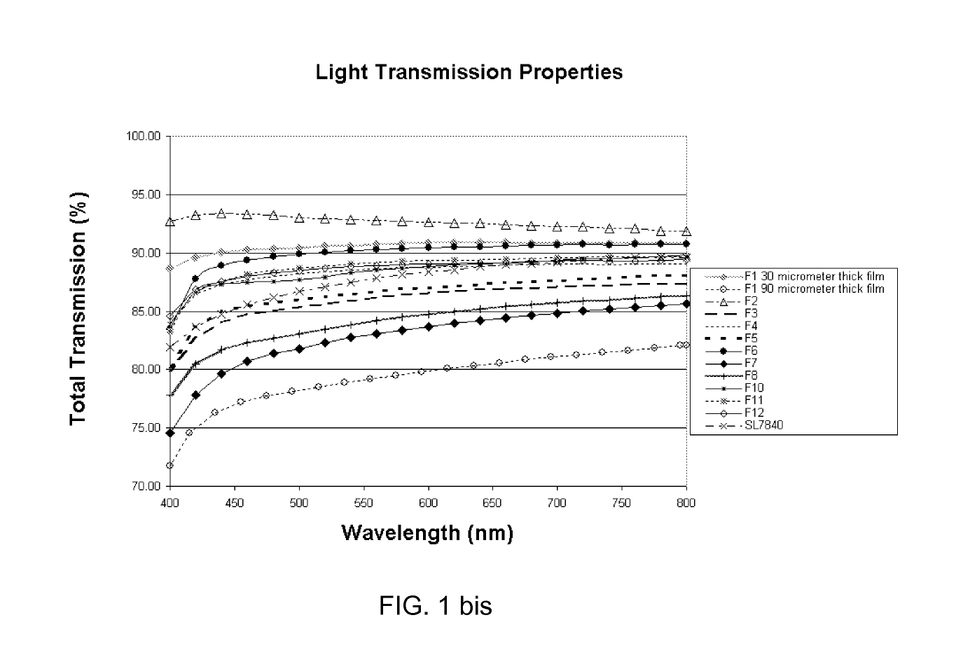

FIG. 1 shows in the light wavelength range from 400 to 800 nm the measured ratio diffused transmitted light/total transmitted light for different layers produced by curing the curable compositions F1-F12 of Table I.

FIG. 1bis shows in the light wavelength range from 400 to 800 nm the measured total transmitted light for different layers produced by curing the curable compositions F1-F12 of Table I.

TABLE II

| Trade | | Chemical | CAS | |
|---|---|---|---|---|
| Name | Supplier | Name | number | Structure |
| PC 1035 | Polyset | Difunctional epoxy terminated siloxane resin | 18724- 32-8 | 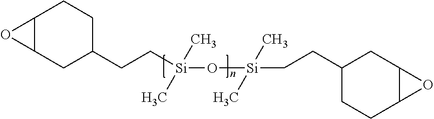 n = 4, 5 |
| Epalloy 5000 | CYC Specialty Chemicals | Epoxidized hydrogenated bisphenol A | 30583- 72-3 | 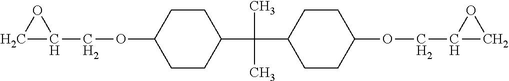 [SMILES: CC(C)(C1CCC(OCC2CO2)CC1)C1CCC(OCC2CO2)CC1] |
| TMPO | Perstorp | Trimethylolpropane oxetane | 3047- 32-3 | 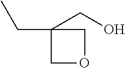 |
| Araldite CY179 | Huntsman | Bis- (epoxycyclohexyl)- methylcarboxylate | 2386- 87-0 | 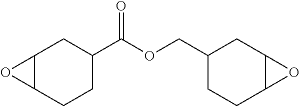 [SMILES: O=C(OCC1CCC2OC2C1)C1CCC2OC2C1] |
| Araldite CY184 | Huntsman | Hexahydrophthalic acid diglycidyl ester | 5493- 45-8 | 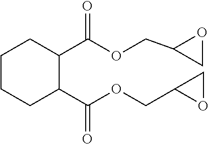 [SMILES: O=C(OCC1CO1)C1CCCCC1C(=O)OCC1CO1] |
| Araldite GY250 | Huntsman | 2,2-bis(4- glycidyloxyphenyl) propane | 85101- 00-4 | 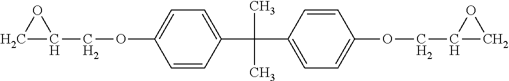 [SMILES: CC(C)(c1ccc(OCC2CO2)cc1)c1ccc(OCC2CO2)cc1] |
| PC1000 | Polyset | Bis[2-(3,4- epoxycyclohexyl) ethyl]tetramethyl- disiloxane | 18724- 32-8 | 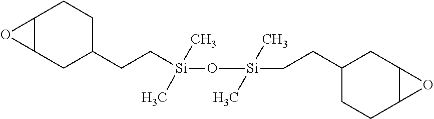 [SMILES: C[Si](C)(CCC1CCC2OC2C1)O[Si](C)(C)CCC1CCC2OC2C1] |
| UV9200 | Momentive | Linear polydimethylsiloxane chainstopped by reactive cycloaliphatic epoxy siloxy groups | Not available | 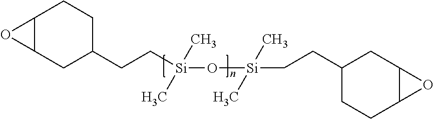 |
| X-40- 2670 | Shin- Etsu Chemical Co. Ltd | Epoxydized cyclic organo- polysiloxane | Not available | 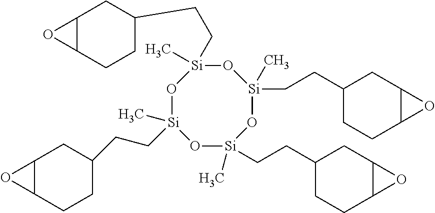 [SMILES: C[Si]1(CCC2CCC3OC3C2)O[Si](C)(CCC2CCC3OC3C2)O[Si](C)(CCC2CCC3OC3C2)O[Si](C)(CCC2CCC3OC3C2)O1] |
| Renshape | Huntsman | Formulated | Mixture | |
| SL7840 | | expoxy resin | | |
| | | “clear to white” | | |
| UV9390C | Momentive | Solution of a bis(4- alkylaryl)iodonium hexafluoroantimonate salt plus photosensitizer in a glycidyl ether reactive diluent | 68609- 97-2 + 71786- 70-4 | 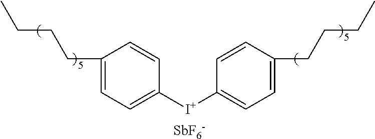 |

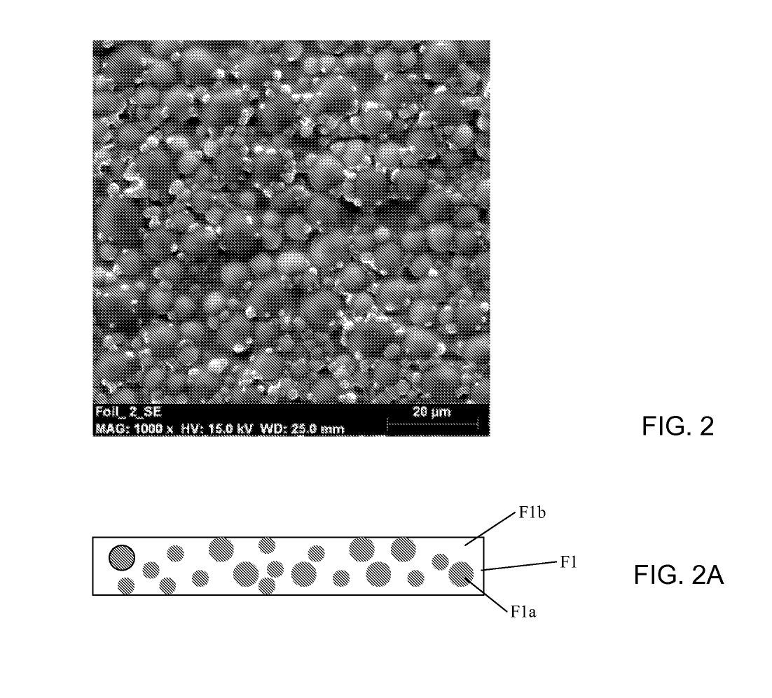

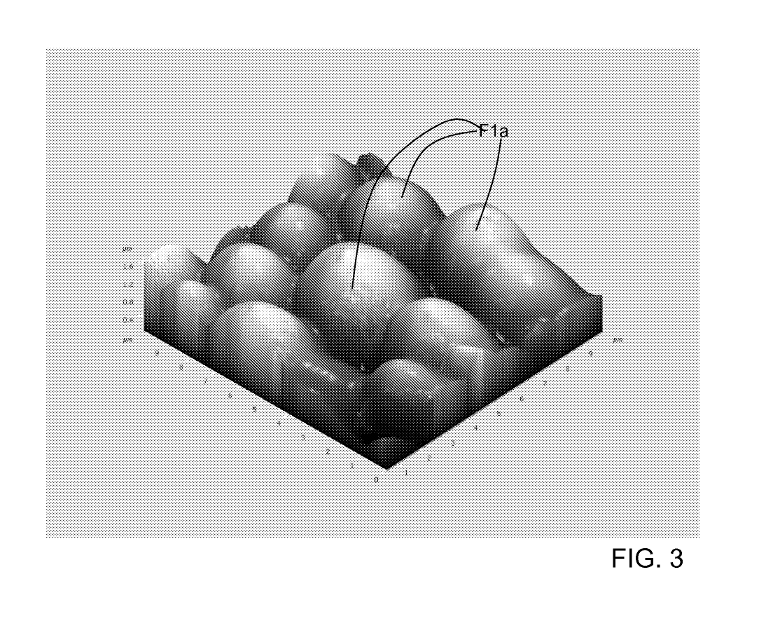

FIG. 1 shows that films obtained by curing an inventive formulation F1 exhibit outstanding light diffusion properties and exhibit a ratio diffused transmitted light/total transmitted light higher than 90% in the light wavelength range from 400 to 700 nm. F1 comprises a mixture of two epoxy silicon resins, PC1000 and UV9200, and a cycloaliphatic epoxy resin CY179. In addition, the dispersion comprises 2 wt % of a cationic initiator. In this composition PC1000 and UV9200 are miscible and produce a clear solution and film, PC1000 and CY179 are also miscible, but the three components together give rise to a phase separation and to films with a white appearance. As observed in SEM pictures (FIG. 2) and AFM pictures (FIG. 3) of a film obtained by curing F1, the three organic substances form a sea-island structure with an island phase F1a (dark-gray in the scheme in FIG. 2A) and a sea phase F1b (white in the scheme in FIG. 2A).

FIG. 3 is an AFM picture of the top surface of a film obtained by curing F1. From this picture we see that in addition to the bulk see-island structure, the film surface is shaped as lens like elements F1a. According to the AFM measurements, the finely distributed island phase F1a forms microlenses having a diameter in the range of 1 to 10 μm.

The light diffusion properties of the 30 micrometer thick film prepared with formulation F1 (film with white appearance) were compared with the ones from 30 micrometers thick films prepared from F2 and F4 (comparative examples). F2 is a mixture of PC1000 and UV9200 and F4 is a mixture of PC1000 and CY179. As observed in FIG. 1, the film obtained from formulation F1 exhibits outstanding light diffusing properties with more than 92% diffuse transmission over total transmission and an elevated total transmission of 90% in the visible range (400 nm-800 nm). On the contrary, films obtained by curing F2 and F4 exhibit much lower diffusion properties, the former with 79% and the latter with 47% diffuse transmission over total transmission in the 400-800 nm range.

The light diffusion properties of films obtained by curing F1 were also compared with those of a 30 micrometers thick film obtained by curing SL7840 (comparative example), which is a commercial clear to white formulation. Films obtained from SL7840 exhibit a much lower diffuse transmission over total transmission (66%) in the 400-800 nm range.

A thicker film obtained from F1 of 90 micrometers was also analyzed in order to check the influence of the film thickness. About 98% diffuse transmission over total transmission was measured in the 400-800 nm region, while keeping the total transmission over 80% (see FIG. 1bis).

The proportions of components present in formulation F1 were varied in the inventive formulation F3 to check if similar properties could be obtained. As seen in FIG. 1, outstanding light diffusing properties were again obtained with a ratio of diffuse transmission over total transmission of 94%, while keeping a high degree of light transmission with an average total transmission of 86% in the 400-800 nm wavelength region.

The non-siloxane component CY179 in F1 was replaced by a glycidyl epoxy component CY184 in F5, by an oxetane TMPO component in F7, by another epoxy component Epalloy 5000 in F8, and by an aromatic epoxy component GY250 in F10. These changes did not affect the optical properties with a diffuse transmission over total transmission measured above 93% in the 400-800 nm range, and a total transmission measured above 82%.

The low molecular weight component PC1000 is an important component in the formulations. It acts as a reactive diluent for both the polysiloxane and the non-siloxane component, and allows the crosslinking of the phase-separating phases induced by the mutually immiscible components. Without the use of PC1000 the film does not cure (see F9 in Table I). Replacing this low molecular weight component by a similar, but slightly higher molecular weight and less polar component PC1035 in F6 did not provide the synergetic and surprising effect obtained with PC1000, and poor light diffusing properties were obtained (44% average diffuse transmission over total transmission in the visible region).

Thermal curing was also tested on formulation F1. A light diffusing foil was obtained after curing a coating of F1 at 170° C. for 2 minutes onto a polycarbonate substrate. The measured optical properties were equivalent to those obtained by curing F1 with UV radiation.

The high molecular weight component UV9200 was replaced by PC1035 in formulation F11. It gave rise to films with poor light diffusing properties with less than 45% average diffuse transmission over total transmission in the visible region. This shows that a minimum size is required for the polysiloxane component. Replacing UV9200 by a cyclic epoxidized polysiloxane in F12 led to the same poor light diffusion properties.

Compositions according to the invention are very useful to produce layers of opaque and light-transmitting materials necessary in the production and manufacturing of light-emitting devices and/or OLEDs.

For the manufacturing of light-emitting devices and/or OLEDs a method of producing an opaque light-transmitting layer is favorably used comprising the steps of:

a) providing a layer with a thickness from 5 to 300 micrometers of a curable composition according to the invention;
b) curing said layer with UV radiation and/or heat.

Such a method to produce opaque light-transmitting layers is simple, fast, precise, accurate, non-expensive, safe, in contrast to other conventionally methods used to prepare such layers.

A “layer” of a given material includes a region of that material whose thickness is small compared to both its length and width. Examples of layers include sheets, foils, films, laminations, coatings, and so forth. As used herein a layer need not be planar, but can be bent, folded or otherwise contoured, for example, to at least partially envelop another component. As used herein a layer can also include multiple sub-layers. A layer can also consist of a collection of discrete portions, for example, a layer of discrete active regions comprising individual pixels.

The layers of compositions according to the invention may be applied to a substrate by all kinds of coating techniques, such as spin coating, slot-die coating, kiss-coating, hot-melt coating, spray coating, etc. and all kinds of printing techniques, such as inkjet printing, gravure printing, flexographic printing, screen printing, rotary screen printing, etc. It is therewith an advantage that the compositions according to the invention comprise no solid particles, so that sedimentation of components in the organic mixture is counteracted.

The produced layers can later be cured by UV radiation and/or heat and give rise to a solid opaque light-transmitting film with optimized optical properties, whereby most light can go through the film, but not through a direct path, because of the scattering and reflections caused by the particles finely dispersed in the organic matrix. The film appears therefore opaque and light transmitting, when it is illuminated by a light source.

Opaque light-transmitting layers produced in this way exhibit typically a light transmission higher than 70% in the light wavelength range from 400 to 700 nm, whereby the ratio diffused transmitted light/total transmitted light is higher than 90% in the light wavelength range from 400 to 700 nm.

1. Photocurable composition curable by ultraviolet (UV) radiation comprising:
A) at least one organosiloxane component A of the following formula (I): 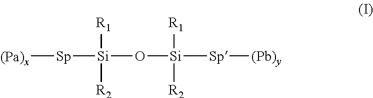
whereby
Pa and Pb are each independently selected from a cationically polymerizable group,
x+y is an integer ≧1,
Sp and Sp′ are each independently selected from a cycloaliphatic hydrocarbon group, a linear aliphatic hydrocarbon group and a branched aliphatic hydrocarbon group,
R₁ and R₂ are each independently a linear or branched aliphatic or cycloaliphatic hydrocarbon group, alkoxy group, aromatic or hetero aromatic group;
B) at least one second organosiloxane component B of the following formula (II): 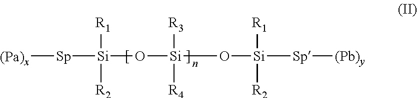
whereby
n is an integer ranging from 7 to 300,
x+y is an integer 1,
Pa and Pb are each independently selected from a cationically polymerizable group,
Sp and Sp′ are each independently selected from a cycloaliphatic hydrocarbon group, an aliphatic linear hydrocarbon group and a branched hydrocarbon group,
R₁, R₂, R₃, R₄ are each independently linear or branched aliphatic or cycloaliphatic hydrocarbon group, alkoxy group, aromatic or hetero aromatic group;
C) at least one epoxy and/or oxetane component C without siloxane groups; and
D) at least one cationic photoinitiator D.

2. Curable composition according to claim 1 comprising:
A) 15-75% by weight of component A;
B) 15-75% by weight of component B;
C) 1-40% by weight of component C; and
D) 0.1-10% by weight of component D;
each based on the total weight of the composition.

3. Curable composition according to claim 1 comprising:
A) 25-65% by weight of component A;
B) 25-65% by weight of component B;
C) 3-25% by weight of component C; and
D) 1-7% by weight of component D;
each based on the total weight of the composition.

4. Curable composition according to claim 1, wherein n in component B is an integer ranging from 7 to 200.

5. Curable composition according to claim 1, wherein x and y are 1 in component A or component B.

6. Curable composition according to claim 1, wherein Pa and Pb are epoxy groups in component A or component B.

7. Curable composition according to claim 1, wherein Pa and Pb are cycloaliphatic epoxy groups in component A or component B.

8. Curable composition according to claim 1, wherein R₁ and R₂ in component A or component B are linear aliphatic groups with 1 to 3 C atoms.

9. Curable composition according to claim 1, wherein component A is bis[2-(3,4-epoxycyclohexyl)ethyl]tetramethyldisiloxane.

10. Curable composition according to claim 1, wherein Pa and Pb in component B are epoxycyclohexyl groups and R₁, R₂, R₃, R₄ in component B are methyl groups.

11. Curable composition according to claim 1 wherein component C is selected from the group of a cycloaliphatic epoxy resins with 2 epoxy groups, diglycidyl ether of hydrogenated Bisphenol A and trimethylolpropane oxetane.

12. Method of producing an opaque light-transmitting layer comprising:
a) providing a layer with a thickness from 5 to 300 micrometers of a curable composition according to claim 1; and
b) curing said layer with UV radiation and/or heat.

13. Opaque light-transmitting layer produced according to the method of claim 12.

14. Opaque light-transmitting layer according to claim 13 exhibiting a light transmission higher than 70% in the light wavelength range from 400 to 700 nm, whereby the ratio diffused transmitted light/total transmitted light is higher than 90% in the light wavelength range from 400 to 700 nm.
